(19) United States
(12) Patent Application Publication
(10) Pub. No.: US 2024/0378985 A1
(43) Pub. Date: Nov. 14, 2024

(54) CHILD ENVIRONMENT MONITORING SYSTEM

(71) Applicant: Evenflo Company, Inc., Miamisburg, OH (US)

(72) Inventors: Jessica Popelka, Charlotte, NC (US); Sharon Ruggieri, Foxboro, MA (US); Michael Brian Williams, JR., Cincinnati, OH (US)

(21) Appl. No.: 18/659,961

(22) Filed: May 9, 2024

Related U.S. Application Data
(60) Provisional application No. 63/465,840, filed on May 11, 2023.

(51) Int. Cl. G08B 21/24; G06T 7/73; G06V 20/59; G06V 40/10; G08B 7/06; G08B 21/22

(52) U.S. Cl. CPC G08B 21/24; G06T 7/73; G06V 20/593; G06V 40/10; G08B 7/06; G08B 21/22; G06T 2207/30196; G06T 2207/30268

(57) ABSTRACT

Embodiments of the present disclosure are generally directed to a child monitoring system. The child monitoring system can comprise various components to monitor a presence of a child, monitor a state of a child, identify a buckle status (e.g., bucked or unbuckled), guide proper installation of a car seat, ensure correct child positioning and car seat configuration, provide notifications of incorrect positioning and/or installation, and the like. The child monitoring system can be used with a car seat, stroller, booster seat, crib, etc. The child monitoring system can be utilized to monitor a child and automatically initiate intelligent actions based on the monitored environment.

### CROSS-REFERENCE TO RELATED APPLICATIONS

This application claims the benefit of U.S. Provisional Application No. 63/465,840, titled “CHILD ENVIRONMENT MONITORING SYSTEM,” filed on May 11, 2023, which is incorporated by reference in its entirety.

### BACKGROUND

Numerous countries around the globe have car seat requirements for the safe transport of children. Typically, car seats are required to be installed in the back seat of a motor vehicle. Often times this leaves an infant or child alone without an adult directly watching over them in the back seat. Furthermore, the adult is generally not available to assist with needs of the child in the car seat as they are driving the vehicle. For instance, a child may grow tired and agitated in the seat and need assistance soothing. A child may also grow restless and bored and desire entertainment. An adult driver cannot offer these things to a child without compromising the safety of everyone in the vehicle.

### DETAILED DESCRIPTION OF THE DRAWINGS

The present disclosure is described in detail below with reference to the attached figures, wherein:

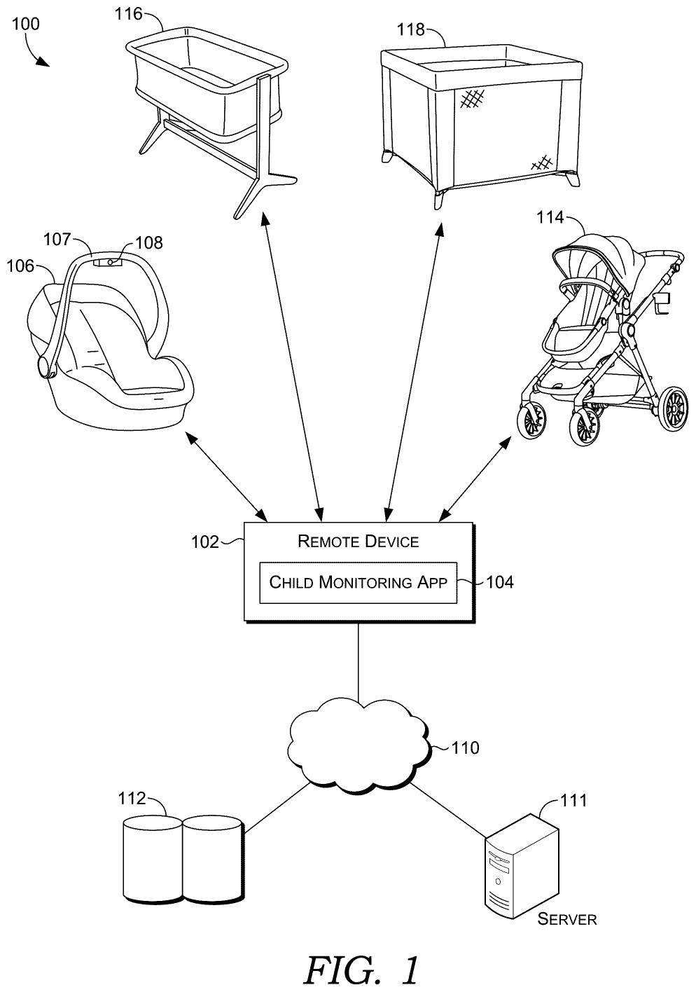

FIG. 1 is a schematic depiction illustrating an exemplary system in which some aspects of the present disclosure may be employed;

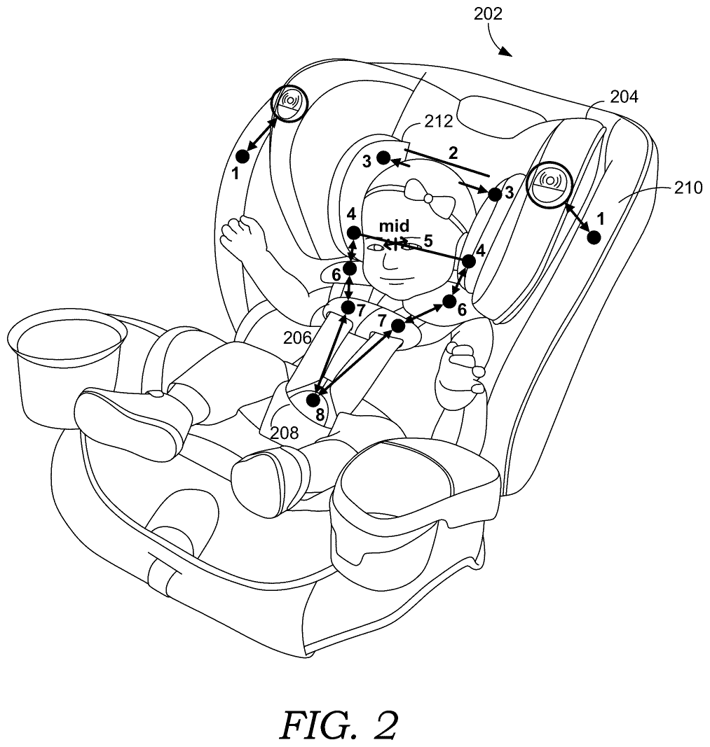

FIG. 2 is an exemplary environment illustrating exemplary fiducial markers in accordance with aspects of the present disclosure;

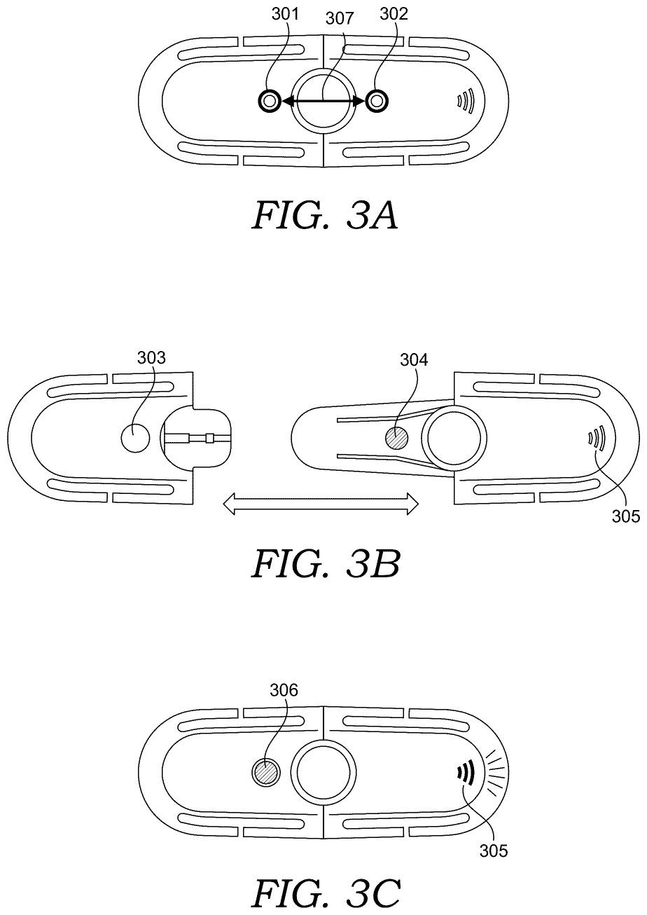

FIGS. 3A-3C depict various positions of a buckle restraint of a car seat in accordance with aspects of the present disclosure;

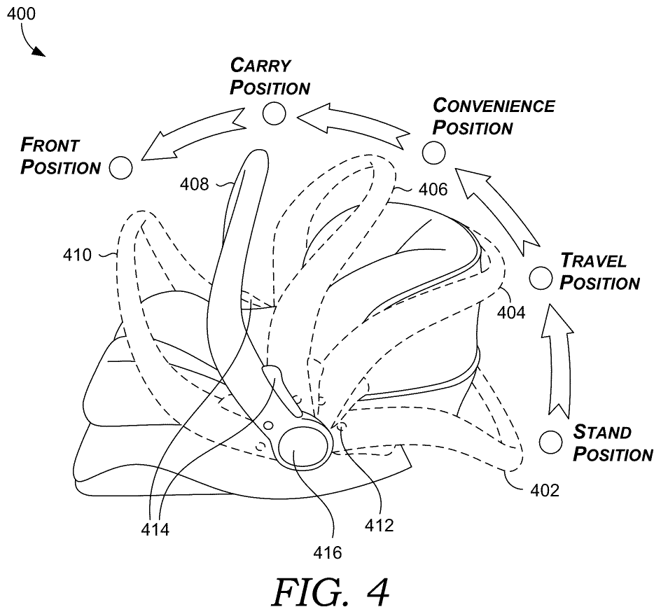

FIG. 4 is a schematic depiction of various handle positions of a car seat in accordance with aspects of the present disclosure;

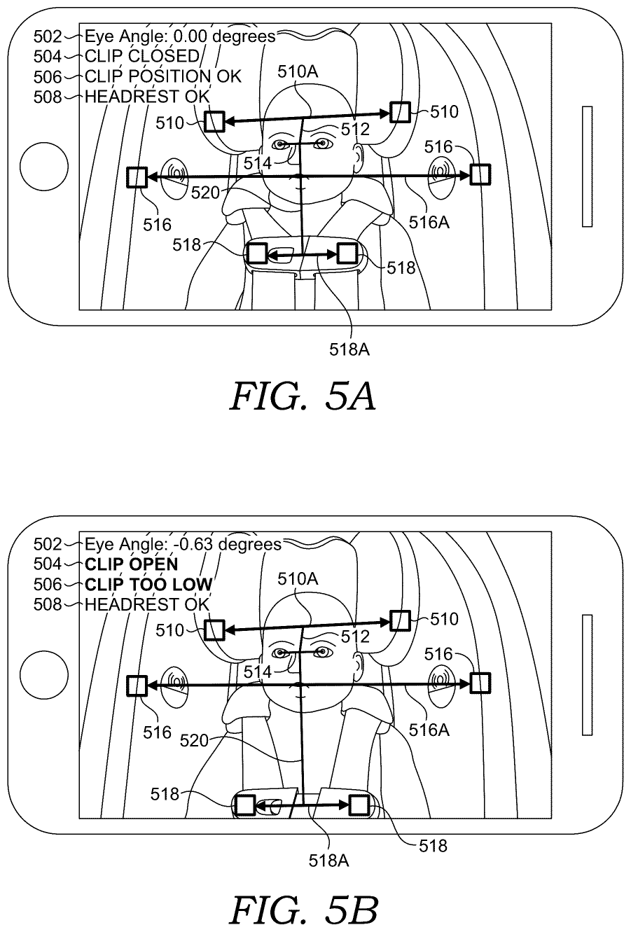

FIGS. 5A and 5B are exemplary graphical user interfaces of a seat safety overlay in accordance with aspects of the present disclosure; and

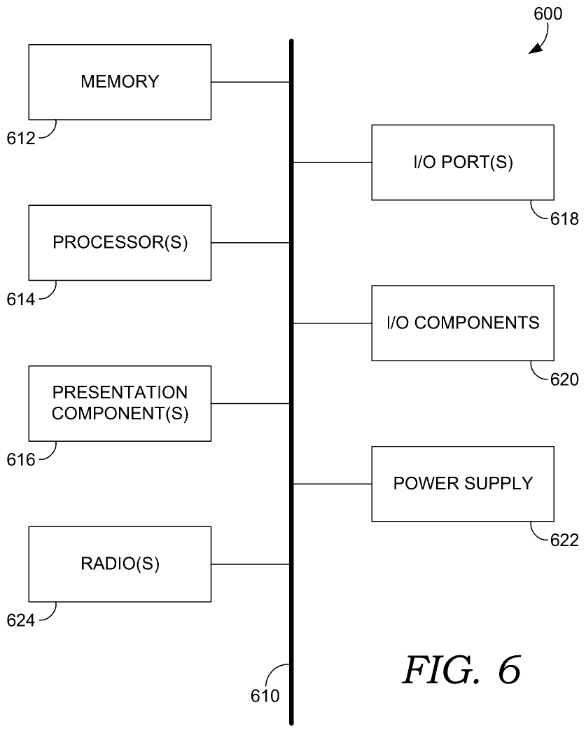

FIG. 6 is an exemplary operating environment in accordance with aspects of the present disclosure.

### DETAILED DESCRIPTION

The present invention provides a monitoring system for child transport items (e.g., car seats, booster seats, strollers, and the like), as well as additional items for which a child environment may need monitored (e.g., cribs, bassinets, playpens, play yards, bouncers, swings, activity centers, high chairs, etc.). For simplicity, the term “car seat” will be used throughout to describe exemplary items but use of this term is not meant to exclude additional items that may utilize features of the present invention. As described in greater detail below, the monitoring system can be utilized for many features including monitoring of a child in a car seat via a camera/video feed, monitoring a presence of a child in the car seat, activating or deactivating features based on a presence, or lack thereof, of a child within the car seat, providing guidance for installation of the car seat, evaluating a position of a child in the car seat, etc. The monitoring system herein may be referred to as an intelligent system, which is used herein to describe a computing system that can gather, analyze, apply, and communicate data from the monitored environment.

In contrast to conventional systems, embodiments of the present disclosure are generally directed to a monitoring system that allows real-time monitoring based on real-time data and automated solutions using the real-time data. For instance, conventional systems can include a mirror to monitor a child in a car seat but a mirror simply shows you a present state of the child and cannot take any action. Furthermore, conventional camera systems provided today also provide simple monitoring by showing a present state of a child without any intelligence to control the car seat environment or features associated therewith based on inferences made by the system. According to some examples herein, the present monitoring system can provide an anti-abandonment feature when a child is detected in a car seat as well as activate or de-activate features (e.g., lights, sounds) based on a presence of a child in a car seat or monitored actions of a child in a car seat. This provides a desirable environment for a child and a safely monitored environment that is easily accessible/viewable to a user. Some examples of the present disclosure can include a monitoring system that aids in supervision of the car seat occupant without interfering with an adult's ability to operate the vehicle. Additionally, a monitoring system that assists the adult with various safety and comfort tasks is described herein.

Referring now to FIG. 1, FIG. 1 depicts an exemplary system 100 for use in embodiments of the present invention. It should be understood that this and other arrangements described herein are set forth only as examples. Other arrangements and elements can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in a memory.

The monitoring system 100 of FIG. 1 includes a mobile computing device 102 including a child monitoring application 104, a car seat 106 having a handle 107 and sensor 108, a network 110, a server 111, and a database 112. Put simply, the mobile computing device 102 (having the child monitoring application 104 installed thereon) can be in communication with the car seat 106 and any components thereof, including the sensor 108 and/or one or more processing devices associated with the car seat 106 to enable/disable performance of certain features described herein. The data exchanged between the car seat 106 and the mobile computing device 102 can be stored in a database, such as database 112 and/or server 111. Specific data exchanged and features controlled on the car seat 106 are discussed herein below. While the car seat 106 is utilized herein as the primary example, monitoring system 100 can be utilized in other products such as a stroller 114, a bassinet 116, a play yard 118, and the like.

The mobile computing device 102 can include any computing device, such the computing device 600 of FIG. 6. The mobile computing device 102 can be in the form of a smart phone, smart watch, a tablet, a laptop, a gaming device, or the like, though a portable form-factor is preferred. The mobile computing device 102 can include one or more wireless communication modules for short-range communication (for example, Bluetooth), long-range communication (for example, Wi-Fi), and carrier service communications (for example, LTE, 3G, 4G, 5G), among other things. The carrier service communications facilitate Wide Area Network (for example, Internet) connectivity from the mobile computing device 102. In some embodiments, the mobile computing device 102 includes a wireless hotspot that activates a Wi-Fi access point within the mobile computing device 102, so that other computing devices within a transmissible range of a Wi-Fi access point can connect thereto and utilize a network 110 (for example, Internet) connectivity of the mobile computing device 102.

Similarly, the car seat 106 can include a computing device, such as the computing device 600 of FIG. 6. The car seat 106 can include one or more wireless communication modules, such as a Bluetooth module, a Wi-Fi module, or any other short or long range wireless communication module that facilitates communication between the car seat 106 (and components thereof, such as sensor 108) and one or more computing devices, such as mobile computing device 102, a vehicle display system (e.g., vehicle infotainment system), or a computing device 600 described with reference to FIG. 6.

The car seat 106 includes one or more sensors illustrated as sensor 108, which can include one or more different types of sensors. In some examples, the sensor 108 can include an I/O component 612 associated with the computing device 600. In some examples, the sensor 108 can include one or more components configured to detect, and record information associated with, sound, light, motion, temperature, humidity, position, etc. In at least some examples, the sensor 108 can include a camera, such as a digital camera, video camera, static camera, etc., configured to record image data associated with the environment 100. In addition, the sensor 108 can include a microphone configured to record sound data. In some instances, the sensor 108 can include an accelerometer or other position-sensing device, configured to detect and assess relative positioning and motion. In some examples, the sensor 108 can detect and record data associated with IR light.

In some examples, the sensor 108 is integrated into (or attached to) the handle 107. In some examples, the sensor 108 can be integrated into (or attached to) other portions of the car seat 106 (e.g., a car seat base). In some examples, the sensor 108 can include multiple sensors (e.g., multiple of the same type of sensor or different types of sensors), which can be integrated in the same general location (e.g., in the handle) or in different locations in the environment and/or on the car seat 106. The sensor(s) 108 can be attached to or integrated within any other portion of the car seat 106 or another location appropriate to monitor a child (e.g., the back of a vehicle seat to monitor a child in a forward facing booster seat, a handle of a stroller to monitor a child in a stroller, a handle or wall of a bassinet to monitor a child in a bassinet, a portion of a crib to monitor a child in a crib, etc.).

In some examples, car seat 106 can include (e.g., on the handle 107 near the sensor 108), one or more output components (e.g., I/O component 612 associated with the computing device 600). For example, the car seat 106 can include speakers, lights (e.g., LED lights), display screen or monitor, haptic vibrational component, etc.

Turning now to specific implementations of the system illustrated in FIG. 1, the car seat 106 is shown as equipped with a sensor 108. In this embodiment, the sensor 108 is attached to or integrated into the handle 107, but could be at any location on or around the car seat 106. Additionally, the sensor 108 can be removably attached to the car seat 106 and can also maintain a range of movement while attached to the car seat 106 (e.g., can rotate). The sensor 108 can include or be associated with one or more processors or a processing unit that enables processing of the information identified or detected by the camera device 108.

Ideally, the sensor 108 monitors the car seat environment and communicates the information to the child monitoring application 104 on the mobile computing device 102. Exemplary data includes a live feed of a child in a car seat, a child's position within the car seat, an indication of when the child is no longer detected in the car seat, an indication that the child is still detected in the car seat and the mobile computing device 102 is identified at a distance that is increasingly far from the car seat, a detection of a foreign object in the car seat, etc. Particular embodiments will be discussed in detail below.

### Child Positioning and Seat Configuration

In at least some examples, the monitoring system 100 can be utilized to suggest child positioning within the car seat 106 and/or seat configuration associated with the car seat 106 (e.g., relative to the child and/or within the environment 100). For example, a series of fiducials (or fiducial markers) may be used to determine the relative position of the child within the seat. An example of a seat is depicted in FIG. 2, and the seat 202 includes a headrest 204, a chest clip 206, a crotch buckle 208, a seat back 210, an inner headrest 212, as well as other elements.

As used herein, a fiducial (or fiducial marker) is a marking or object placed in a field of view for use as a point of reference. Fiducials can be used in various manners to assess conditions associated with an environment, such as an environment associated with the car seat 202. In at least some examples, the sensor 108 can record data (e.g., image data) that is associated with one or more fiducials associated with the car seat 202. For example, image data can include a depiction or representation of a first fiducial and a position of the first fiducial relative to the sensor 108 and be used to determine various values (e.g., distance from the sensor). For example, using the image data, a physical size (e.g., height, width, diameter, etc.) of the fiducial can be measured and compared to a reference size (e.g., based on the physical size when the fiducial is at a known distance from the sensor), and based on the comparison, a distance between the fiducial and sensor can be calculated. In some examples, the image data can include a depiction of the first fiducial and a depiction of one or more other fiducials, and relative positions between the fiducials can be determined.

An exemplary schematic diagram of fiducials to use for child positioning is provided in FIG. 2. As shown, a child is placed within a car seat 202. A series of fiducials labeled as fiducials 1-7 are described herein and are not meant to limit potential fiducials that could be utilized (i.e., additional fiducials may be added to the car seat in different locations and some fiducials shown may be eliminated in view of additional fiducials). It should also be noted that not all fiducials may be required to ensure proper child positioning in within the car seat 202.

In at least one example, the present disclosure can assess a position of the headrest 204 relative to the back portion 210 of the car seat. For example, image data can be recorded (e.g., via the sensor 108) that includes a first fiducial positioned on the back portion 210 of the car seat and a second fiducial 2 on the head rest 204. In examples, a relative position of the first fiducial relative to the second fiducial can be determined to assess a position of the headrest 204 relative to the back portion 210. For example, the relative position can include a distance, an angular orientation (e.g., relative to some reference line), or any combination thereof.

Fiducial 2 utilizes markers on the back of the headrest 204 to determine a height of the top of a child's head relative to the headrest back. For example, image data can be recorded (e.g., via the sensor 108) that includes a third fiducial 3 positioned on the headrest 204 and/or the inner headrest 212 and that includes a top of the child's head. In examples, a relative position of the third fiducial 3 relative to the top of the child's head can be determined to assess a position of the headrest 204 relative to the child. For example, the relative position can include a distance, an angular orientation (e.g., relative to some reference line), or any combination thereof.

Fiducials 3 and 4 can be utilized together to determine a full inner headrest 212 position. For example, image data can be recorded (e.g., via the sensor 108) that includes a third fiducial 3 and a fourth fiducial 4 positioned on the inner headrest 212 and that includes a child's head. In examples, a relative position of the third fiducials 3 and fourth fiducials 4 relative to the top of the child's head can be determined to assess a position of the inner headrest 212 relative to the child.

Fiducial 5 is a midpoint of a line between a child's eyes. This is used to determine a central portion of a child's head accounting for a head angle. For example, image data can be recorded (e.g., via the sensor 108) that includes the third fiducial 3 and fourth fiducial 4 of the inner headrest 212 and that includes a child's head. In examples, a relative position of the third fiducials 3 and fourth fiducials 4 relative to the child's head can be determined to assess a position of the child's head and identify a midpoint of a line between the child's eyes. In other aspects, other facial markings can be used to determine a head angle, such as a child's chin location. Specifically, if a chin is not at an appropriate angle (e.g., the chin is angled downward more than a predetermined angle value) then an alert can be triggered. A child's head angle is particularly important to maintain a proper airway of the child.

Fiducial 6 can be used to measure, estimate, or infer a shoulder height of the child. For example, image data can be recorded (e.g., via the sensor 108) that includes a sixth fiducial 6 positioned below the headrest 204 and that includes a position generally aligned with a child's shoulders (e.g., the fiducial 6 can be a marker affixed to a shoulder strap). In examples, a relative position of the sixth fiducial 6 relative to one or more other fiducials or areas of the child's body (e.g., shoulders, top of head, etc.) can be determined to assess a position of the child.

Fiducial 7 illustrates chest clip fiducials for determining position of a chest clip 206 relative to a crotch buckle 208, shoulders (fiducial 6) and head (fiducials 2 and 5). For example, image data can be recorded (e.g., via the sensor 108) that includes a seventh fiducial 7 positioned on the chest clip 206 and one or more of an eighth fiducial 8 positioned on the crotch buckle 208, the sixth fiducial 6 positioned below the headrest 204, a second fiducial 2 positioned on the headrest 204, and a fifth fiducial 5. In examples, a relative position of the seventh fiducial 7 relative to any one of the other collected fiducials (e.g., eighth fiducial 8, sixth fiducial 7, sixth fiducial 6, second fiducial 2, and/or fifth fiducial 5) can be determined to assess a position of a child, a position of the chest clip 206, a position of the crotch buckle 208, and the like.

The fiducials described can be identified using the sensor 108 (e.g., image sensor, such as a camera). Once captured by the sensor 108, the sensor 108, or another computing device in communication therewith (e.g., by a computing application running on a computing device associated with the car seat and/or mobile computing device), can determine the headrest height and confirm the height is appropriate for the child based on the child's size and age. Similarly, the monitoring system 100 can detect a head position is appropriate within the headrest. For instance, by determining the height of the center of the face of the child by taking the midpoint of the line between the child's eyes (fiducial 5), the head position can be verified.

The monitoring system 100 can also determine the position of the chest clip 206 and present a notification to a user, via the child monitoring application 104, if the chest clip 206 is detected at a position that is above or below a reference height for the child (e.g., suggesting that the clip may be more functional at a different height). In this instance, the child monitoring application 104 can provide a graphical overlay (e.g., via augmented reality imaging) to show a desired position of a simulated chest clip vs. the current position of the chest clip to help guide the user to position the chest clip correctly for the specific child based on the child's personalized information (e.g., age, height, and weight). A similar overlay can be provided with respect to headrest positions relative to an eye mid-point and is not limited to chest clip positioning.

The graphical overlay can be a translucent overlay of the correct position, such that a user can easily identify the correct position versus the current position and identify adjustments needed to align the two positions. The graphical overlay could be a single image to serve as a guide to a user or a live feed with a continuously generated overlay.

The monitoring system 100 can determine positioning of the chest clip 206, shoulder strap pads, the headrest, and the like, in various ways. In one aspect, a handle, such as handle 107 and one or more processing devices associated therewith (or with the car seat 106) can capture an image of the car seat 106 and calculate a current and correct position of one or more elements of the car seat 106, such as a chest clip, head rest, etc. The one or more processing devices associated with the handle/car seat can generate an overlay and communicate that overlay result to the user, either via a display on the handle 107 or via the application. Alternatively, the handle 107 can capture an image of the car seat 106 and calculate the current and correct positioning of the one or more elements of the car seat 106 while the application generates the overlay based on the current and correct positioning and presents said overlay to the user via the user's mobile device. In another aspect, the handle 107 can capture an image of the car seat 106 and provide the image to the application. The application can then calculate the current and correct positioning of the one or more elements of the car seat 106, generate the overlay based on the current and correct positioning of the one or more elements of the car seat 106, and provide the results/overlay to the user via the user's mobile device. In yet another aspect, the user's mobile device can be used to capture the image of the car seat 106 and the application (on the mobile device) can calculate the current and correct positioning of the one or more elements of the car seat 106, generate the overlay based on the current and correct positioning of the one or more elements of the car seat 106, and provide the results/overlay to the user via the user's mobile device. The results/overlay communicated to the mobile device can include instructions to correct the positioning identified in the image and/or a graphical overlay to act as a guide to adjust the one or more elements until the correct positioning is achieved.

Because the monitoring system 100 can check positioning for a plurality of elements of a car seat, the monitoring system 100 may utilize a series of alignments to ensure correct positioning on any of the one or more elements of a car seat that can be analyzed. An exemplary series of alignment steps can include the following, in no particular order:
(i) Adjusting a seat angle and position for a child's age, weight, height, etc., as entered by a user or inferred from previous data entered by a user. This aspect can utilize an accelerometer to confirm correct position rather than fiducials.
(ii) Adjusting headrest height relative to a midpoint of the eyes (or any other facial marker). This adjustment can be monitored utilizing augmented reality (e.g., a graphical overlay) or fiducials.
(iii) Adjusting shoulder straps until a seat strap sensor detects the angle of the straps is correct or according to a manual description to the user of correct positioning.
(iv) Adjusting a chest buckle relative to shoulder straps. This can be monitored utilizing augmented reality (e.g., a graphical overlay) or fiducials.

The above alignment steps can use a combination of non-vision sensors (e.g., accelerometers, strap tension, strap angles, etc.), manual checking, and automated visual checking to monitor alignment/fit. The above-described graphical overlay can display a status of all steps of the fit-check. The fit-check can be automatically run upon detection of a child in the car seat 106 or manually initiated. The fit-check can also include some steps that are automatically run upon detection of a child while other steps are not automatically run and are manually initiated, as configured by a user. In aspects, the system can be configured by a user for automatic (no user input) or manual (user input required) initiation based on one or more of a specific feature, user preferences, and the like.

Additional alignment indicators may comprise visual indicators on one or more elements of the car seat such as the shoulder straps, chest clips, etc. For instance, to evaluate correct positioning of the chest clip along the shoulder straps, the straps may include visual indicators to let a user know the position is correct such as measured markings (e.g., similar to that of a ruler) along the shoulder straps. Alternatively, the material of the shoulder straps may be printed or embedded with markers to line up a chest clip evenly on both shoulder straps including UV markers, IR markers, and the like.

Furthermore, the visual markers along the shoulder straps can be used to identify if one or more portions of the shoulder strap is twisted. Visual markings may differ for a front side of a strap and a back side of a strap (e.g., different types of indicators for a front side and a back side, different color of material for a front side and a back side, and the like) such that a user or the one or more sensors can detect when a back of a strap is visualized (i.e., the strap is twisted such that a portion of a back of a strap is visible when it should not be visible). This may be indicated in a graphical representation to a user that the shoulder strap is twisted based on a back side of a strap being detected by a sensor.

In some seats, shoulder straps may be equipped with shoulder pads on each shoulder strap. In aspects, the shoulder pads may be aligned such that an indicator that should not be visible on the shoulder straps is visible to one or more sensors. This can trigger an alarm of the system 100 to notify the user that the shoulder pads are not aligned on the shoulder straps. Alternatively, the absence of a fiducial/indicator may be a trigger to the system that the alignment is not correct. For instance, a shoulder strap may include an indicator or a plurality of indicators (e.g., an indicator above a shoulder pad and an indicator below a shoulder pad) that should be visible when the shoulder pad is in a correct position. Thus, the absence of the indicator can trigger an alarm of incorrect alignment.

As is apparent from the various aspects described above, the positioning analysis may be performed without the use of the handle 107 and, as such, can be utilized primarily from the application residing on a mobile device. Conversely, the handle 107 may be equipped with capabilities to notify users of incorrect positioning without the use of the application/mobile device.

An exemplary graphical overlay is illustrated in FIGS. 5A and 5B. As is shown in FIG. 5A, an exemplary display may include an image of a child in a car seat with positioning information provided as a graphical overlay. Indicator 502 provides an eye angle measurement using fiducial marker 514. Indicator 504 provides an indication of whether a chest clip is open or closed. Indicator 504 provides this determination using fiducials 518 and a distance 518A between the fiducials 518. In a closed position, distance 518A is a known value or a known value range. In aspects, any value higher than the known value is determined to indicate an open position of the chest clip. In other aspects, any value lower than the known value is determined to indicate an open position of the chest clip (e.g., each end of the chest clip may be overlapping and, thus, the value would be less than the known value). Indicator 506 provides an indication of whether the chest clip is correctly positioned, too high, or too low. This can rely on positioning of fiducials, such as fiducials 518, fiducials 510, and fiducials 516 relative to one another. The positioning of the chest clip can also be determined by distance 520 from the fiducials 518 (or the reference distance marker 518A) to an eyeline reference 514. Thus, the chest clip may be determined to be appropriate at a predetermined distance from a child's eyeline reference 514. A value greater than the predetermined distance for distance 520 may be determined to be positioned too low for the child, while a value lower than the predetermined distance may be determined to be positioned too high for the child. Additionally, indicator 508 provides an indication of correct positioning of the headrest using one or more of fiducials 510 and fiducials 516 and distances between the two including distance 510A and distance 516A, as well as measurement marker 512 indicating a distance between the distance 510A marker and the eyeline reference 514.

Although the graphical overlay is described herein with respect to particular fiducials, it should be understood that the fiducials discussed herein are exemplary in nature and can be modified. For instance, the positioning of the chest clip is discussed herein with respect to the eyeline reference 514. However, the chest clip position can also be evaluated with respect to a chin location of the child or a forehead location of the child. Facial geometry and facial markers can be utilized to identify any relevant facial marking (e.g., eyeline, chin midpoint, bottom of chin, forehead midpoint, ear midpoint, etc.) to associate with a fiducial and measured with respect to other fiducial markers, such as the chest clip location. In addition to the type of fiducial reference used, the location of the fiducial references can also be adjusted such that the fiducials can be located wherever practical to evaluate position of a child in a car seat and/or positioning of the seat elements (e.g., chest clip, should strap, etc.). Furthermore, while facial markers/geometry is referenced above, it should be understood that other non-facial body markings may be utilized by the system such as shoulder measurements, chest measurements, and the like.

FIG. 5B illustrates an incorrect positioning illustration. In particular, indicator 504 indicates that the chest clip is open while indicator 506 indicates that the chest clip is too low. Indicator 504 is triggered to provide an open status based on the distance 518A between fiducials 518 of the chest clip, as described above (i.e., the distance between the fiducials is greater or less than a predetermined value). Similarly, indicator 506 indicates that the chest clip is too low based on the distance 520 between the clip itself and the eyeline reference 514. As previously mentioned, the absence of indicators can also trigger an alarm such as an indicator that should be visible when correctly aligned not being visible or an indicator being out of frame of the graphical overlay.

As illustrated in the figures, all indicators may provide a real-time status and adjust their status outputs as the user moves through the installation process. While illustrated in a single interface, the system 100 can alternatively be configured to provide updates in a step-wise approach. For instance, the indicator 506 may not indicate that the chest clip is too low until the chest clip is in a closed position and illustrated as closed by indicator 504.

When an indicator is determined out of compliance for transport (i.e., the chest clip is open, too low, too high, a child is positioned incorrectly, etc.) then the system 100 can provide a graphical representation/alert on the display to the user. The graphical representation may include providing indicators that are out of compliance in a different color (e.g., red, bold, etc.) than indicators that are satisfied. The system 100 can also provide graphical indicators (e.g., exclamation points) near indicators that are out of compliance. The system 100 can also provide an alert via a pop-up alert, audio alert, etc., to ensure a user is aware of the indicators that need attention (i.e., indicators that are not in compliance with transport).

In addition to positioning, the system 100 can assist in determining tightness of the harness. For example, using accelerometers in one or more of the sensor 108 and the chest clip 206, relative movements due to impulses can be compared to one another. If the chest clip 206 is moving substantially more than the sensor 108, which is in a fixed position in this example, the user can be notified, via the child monitoring application 104, that the harness is likely loose. Additionally, tightness could be determined by comparing accelerometer data in the sensor 108 to movement that is detected in frame-to-frame image data. For instance, the sensor 108 can record a feed of a child in the car seat 106. If items, such as the child, a crotch buckle 208, a chest clip 206, a headrest 204, etc., in the frame-to-frame image data from the recorded feed are moving substantially more than the sensor 108, the user may be notified, via the child monitoring application 104, that the harness may be loose. Put another way, the items (e.g., crotch buckle 208, chest clip 206, etc.) may be identified at a first location in a first frame and a second location in a second frame. A difference between the first and second locations of the items (e.g., a distance between the first and second locations) that is larger than a difference in a first frame location and a second frame location of the sensor 108 may indicate that the item is moving more than the sensor 108.

In addition to positioning and tightness, the system 100 can detect foreign objects within the environment that may be hazardous to a child or become hazardous (e.g., become a projectile in the event of a car crash). Machine learning may be employed by training an image classification algorithm to detect foreign objects using a dataset of images with and without foreign objects in car seats, or using a dataset of images of objects. The detection algorithm could be run by the car seat (e.g., the handle/one or more processing devices associated therewith), the application on the user's mobile device, a cloud service, or a combination thereof. The machine learning can be used in combination with object detection methods/object recognition models to increase accuracy.

As an example, supervised training methods can be used on a neural network, such as a convolutional neural network (CNN), to identify foreign objects. To do so, a training dataset comprising labeled training data may be used. The labeled training data can comprise images of known objects that have been labeled as foreign objects that should not be present in a car seat with a child. The neural network is trained using the training data and, as a result, the trained neural network is configured to receive an image, a still image or an image from a real-time image stream, as an input, and in response, identify whether there is a foreign object in the image. This can trigger an alert to a user, via the system 100, that a foreign object is present and should be removed. The alert may comprise an indication of what the foreign object is, where it is located, an image illustrating the foreign object in the environment, and the like.

Alerts to users via the child monitoring application 104 can be in many forms including an audible alert, a visual alert (e.g., lights), tactile alerts (e.g., vibrations), pop-up notifications, and the like. The alert format can be customized by a user in some instances. At other times, the nature of the alert may be determined by the monitoring system 100 based on the alert. For instance, if the alert to be communicated is an anti-abandonment alert or a high priority alert, then the alert may be communicated in all possible formats, e.g., audio, visual, tactile all at once (simultaneously). The high priority alert may be communicated via a siren or a spoken alert from a computing device. Conversely, if the alert to be communicated is a low priority notification (e.g., a notification from a seat manufacturer describing registration information) then it may be a lower priority and comply with any user-determined alert formats.

Additionally, many of the alerts or determinations made herein are based on an age, height, and/or weight of a child occupant. Each of those data points (i.e., age, height, and weight) can be input by a user into the child monitoring application 104. A date of birth could be entered such that the monitoring system can automatically update the age of the child annually without additional input from the user. Height and weight could be initially entered by the user and then updated periodically based on reminder alerts from the monitoring system 100 to update information. The prompts to update information could be more frequent (e.g., monthly) when a child is younger as they tend to change more frequently while the prompts could be spaced further out (e.g., yearly) as a child ages and changes in growth slow down. Additionally, a user can manually input a change/update in information at any time. In other embodiments, growth curve projections can be stored and accessed by the monitoring system 100 to estimate a child's size based on previous data points. Further, multiple child profiles can be stored (e.g., in database 112) such that a user can switch between child profiles, including the child's personalized information, when the car seat needs to be used for a different child (e.g., sibling children both using a car seat at different times).

Alerts can also be based on the installation, position, and/or orientation of the car seat. For instance, a user can input whether the car seat is installed in a second or third row position of a vehicle and whether the seat is a rear-facing or forward-facing orientation. A user can also input whether the seat was installed using seatbelts or a LATCH system of a vehicle. The monitoring system 100 can utilize this data to deliver relevant alerts, i.e., some alerts that apply to a child seat in a rear-facing orientation may not be applicable to a forward-facing seat, etc.

### Presence Detection

In some examples, the monitoring system 100 can determine a presence of a child based on data recorded by one or more sensors. For instance, presence can be detected based on image data (e.g., where the sensor 108 includes a camera), a status of a buckle (e.g., a sensor associated with a chest clip or a crotch harness buckle and determining when the clip or buckle is latched or unlatched), a handle position (e.g., a sensor associated with the handle of the car seat and determining a position of the handle), or various other sensors that may be used with car seat 106. For example, a pressure sensor could be integrated into a seat portion of the car seat 106 such that an occupant being placed into the car seat 106 could be detected. Standard facial detection can be used or machine learning algorithms could be used to determine the presence of a child in the car seat 106 (e.g., based on image data collected by the sensor 108). In some examples, the sensor 108 can use IR sensitivity to determine the presence of a heat generating object to determine the presence of a child.

Machine learning may be employed by training an image classification algorithm to detect a “car seat with a child” and a “car seat without a child” using a dataset of images with and without children in car seats, or using a dataset of images of children. The detection algorithm could be run by the car seat (e.g., the handle/one or more processing devices associated therewith), the application on the user's mobile device, a cloud service, or a combination thereof. The machine learning can be used in combination with facial detection methods to increase accuracy.

The sensor 108 can, as previously mentioned, identify a face of a child to determine a presence of a child (e.g., when face is detected then presence is also detected). Additionally, the sensor 108 can utilize an angle sensing device (e.g., accelerometer) to determine presence. For instance, when the car seat handle is in a “travel” position (shown in FIG. 4) the seat is considered to have a child present. The “travel” position can be based on one or more different sensors, including the sensor 108, one or more other sensors near the trigger release for the handle, or any other sensors associated with the handle.

The sensor 108 can also visually determine (e.g., based on image data) if a buckle is open or closed. As used herein, buckle refers generally to either the chest clip or the crotch harness buckle of a car seat. A variety of methods can be used to determine if a buckle is closed. First, fiducial markings on the ends of a buckle such that a sensor can use them as known references to determine distance and relative position of the buckle ends to each other can be used. When the ends of the buckle are within expected distances to one another (e.g., based on the distance as measured in the image data), the buckle is determined to be “buckled” and when the ends are not within expected distances to one another then the buckle is determined “unbuckled.” This is illustrated in FIG. 3A, where fiducial markings 301 and 302 are within an expected distance 307 to one another so the buckle is determined to be “buckled.” Fiducial markings 301 and 302 could also be IR reflecting.

Fiducial markings on one end of the buckle such that fiducials appear in one manner when the buckle is not buckled (open) and a different, machine distinguishable mark is visible when the buckle is buckled (closed) can be used to determine a buckle status. Such an exemplary embodiment is illustrated in FIGS. 3B and 3C. In FIG. 3B, fiducials 303 and 304 are viewed in one way when the buckle is open or unbuckled. Additionally, LED indicator 305 is not activated as the buckle is in an open state as shown in FIG. 3B. FIG. 3C, however, illustrates that fiducials 303 and 304 are lined up now such that marker 306 is visible to a user. Further, since the buckle is in a closed state, LED indicator 305 is now blinking to show that the buckle is closed.

In some examples, LED indication can also be in non-visible (e.g. infrared) spectrum to not disturb the driver or seat occupant with extraneous visual indications. LED indication can be in a pattern to indicate a status, e.g. battery good or battery low. Communication in the infrared spectrum can also be filtered and detected by special infrared sensors (e.g., as one type of the sensor 108), in addition to cameras sensitive to infrared.

In some examples, the chest clip can include an IR emitter and battery that sends a coded message via IR pulses. In addition, the handle can receive this information via camera or IR receiver. Use of the IR spectrum can, in some instances, avoid potential mixed signals from other lights in the environment (e.g., other lights on the handle).

In some examples, the chest clip buckle can present an IR reflective surface when buckled, which can operate in combination with a handle (or other part of the car seat) containing an IR transmitter and/or IR receiver. The receiver (e.g., sensor 108) can in some cases be a camera. In some examples, the receiver can include a non-camera IR receiver. In at least some examples, fabric of the car seat and unbuckled chest clip material could be chosen to be non-reflective, such that when a child is not in the seat and buckled, no reflection of the IR signal occurs and the seat is seen as unbuckled.

Fiducial markings could additionally be reflective surfaces or IR markers. For instance, a reflective surface(s) on the buckle that is presented/hidden when the buckle is buckled/unbuckled could be used to determine buckle status. A camera device used herein may use a constant illumination source to track position of the surface(s), or it may cycle on and off to check for presence of the reflection. In this manner, false positives from other light sources such as sunlight can be reduced. Patterns or shapes that are partially obscured or completed when the buckle is “buckled” vs “unbuckled” (e.g., a QR code that is formed when the ends are buckled) can be used to determine buckle status.

In embodiments, active buckles could also be used. Active buckles, as used herein, refer generally to buckles that actively present their status (e.g., open or closed) to the monitoring system 100. Active buckles can transmit their status via wired sensors, wireless signals, active illumination, sound (including ultrasound), etc., such that the camera system can receive the status.

Using the monitoring system 100 having the sensor 108 therein, reliable presence detection (RPD) can be achieved. That is, the system 100 can monitor, update, and send notifications based on, a presence status associated with the system (e.g., a status that indicates whether a child is present). For example, in some instances the system 100 can update a presence status to indicate “present” when a buckle is buckled (e.g., based on fiducials and/or directed reporting by an active buckle). Additionally, a condition can specify that when a face is detected, then a buckle should be buckled. If either condition is true while the other is false, an alert can be provided to the user for presence confirmation. For example, if a face is detected (e.g., a child's face) but the buckles are not buckled, a presence confirmation alert can be communicated to the mobile device 102. The user can then specify the child presence state (e.g., present or not present). This manual indication of a child presence state can be the default and remembered (e.g., stored in database 112) until both face detection and buckle status detection indicate a change in status. In this manner, child presence is very reliable. In the event the alert is not answered, a default state may be used as configured by the system. Alternatively, if the alert is not answered, an escalation protocol may be used to draw attention to the alert (e.g., if the alert was provided via a vibration previously a second alert may be sent with sound, an additional alert may be communicated to an alternative device, etc.).

In some examples, a presence status can be used to control other features associated with the system. For example, it can be useful to limit some features to operate or be activated when the child is present, but deactivated when a child is not present. For example, a cry detection feature (via microphone) may be less useful when a child is not present (e.g., can trigger unnecessary operations). As such, cry detection features can be turned off/deactivated when a presence status indicates that no child is present. In some instances, this can reduce the likelihood of the system responding to other non-child sounds or cries of children in other seats. Thus, a microphone used for cry detection could be disabled if a child is not present.

Another feature that can be automatically activated/deactivated based on presence, or lack thereof, is activation of a remote monitoring application (shown as child monitoring application 104 in FIG. 1). For example, when a child is present in the seat, the monitoring application could be automatically launched/opened on a user's mobile phone (or any mobile computing device) in a hands-free mode for driving such that the child is displayed without the user opening or configuring anything while driving.

Environmental factors such as lights, sounds, soothing vibrations, fans, etc., may also be automatically controlled by the monitoring system. Each of these environmental factors can be intelligently deactivated when a child is not present. Selective activation of each feature is also provided herein utilizing a combination of facial detection, eye detection, motion detection, and audible cry detection to detect a status of the child. For example, various modes can be activated based on environmental detections as follows:
(1) Sleep Mode: eyes closed, no movement detected, no crying detected;
(2) Go to Sleep Mode: eyes open, no movement detected, no crying detected;
(3) Entertainment Mode: eyes open, movement detected, no crying detected; and
(4) Soothing Mode: crying detected.

The four listed modes are merely exemplary and not meant to limit the addition or deletion of additional modes. Each of the above modes can be associated with different features, each of which can be configurable by a user. Exemplary embodiments of features associated with each mode are provided below.
(1) Sleep Mode: white noise activated through speakers, IR illumination only, camera image very slowing refreshing (on mobile app) to avoid distractions;
(2) Go to Sleep Mode: bedtime music activated through speakers, dim lighting, red-ish non-blue lighting, camera image very slowly refreshing (on mobile app) to avoid distractions;
(3) Entertainment Mode: fun songs activated through speakers, lights moving in time with the music and/or in response to child-detected movements, camera image very slowly refreshing (on mobile app) to not distract the driver; and
(4) Soothing Mode: If the previous mode was sleep, attempt to use sleep mode again when cries are detected. If previous mode was entertainment, try a different set of actions. Camera image quickly refreshing to allow the user to determine cause of distress. The camera can present options via app or voice command to let the user determine how to respond.

Each of the above-listed modes may be uniquely activated based on a specific use. For instance, a “Go to Sleep Mode” may be available when used with, for example, a bassinet where sleeping may be encouraged.

The monitoring system 100 can also reduce power consumption by intelligently and automatically (without user input) reducing or disabling child monitoring features until a child is present. For example, unneeded parts of circuitry may be powered down (e.g., microphones for cry detection are not needed if a child is not present). Further, necessary parts of the circuitry (e.g., camera device and face detection) can be activated but on a reduced cycle, e.g., every minute instead of every second. A necessary versus unneeded part of circuitry may be determined based on presence; if a child is present, features are needed whereas if no child is present, features are not needed. Alternatively, if a child is not present, each feature of the car seat could be deactivated except for the camera device (face detection and buckle status detection) to determine when a child is present in the seat.

The monitoring system 100 can also aid in anti-abandonment initiatives. Children being left behind unattended in vehicles can be an unsafe situation for many children that could be avoided in many instances. The monitoring system 100 can be configured to activate a series of emergency features when it detects the child is alone in a vehicle. The monitoring system 100 can detect when a user has moved away from the car seat 106 based on a position of a separate device (e.g., the user's mobile device, a key fob, dongle, tracking tiles, etc.) relative to a position of the car seat 106. In embodiments, the car seat 106 and/or the sensor 108 and the mobile computing device 102 can maintain an active connection such that the monitoring system 100 can quickly and easily identify when a received signal strength between the mobile computing device 102 and the car seat 106 is less than a predetermined signal strength threshold. This high priority alert can, as previously mentioned, be delivered consistent with system configurations for high priority alerts. For example, the alert could be a siren, flashing lights, a spoken alert (e.g., Child Left in Vehicle), texts, phone calls, etc. In embodiments, the monitoring system 100 could initiate a phone call to the user or to emergency services. In that example, the monitoring system 100 could provide GPS coordinates of the child and a photo of the child to emergency services. Both the photo and GPS coordinates reduces false positives; if an emergency alert comes in with a photo of an empty seat, emergency services will know not to respond.

In examples, the system can communicate with one or more of a variety of other systems and/or devices. For example, in some instances the system can communicate with a variety of different infotainment systems, such that information can be exchanged with the sensor 108 and the handle (e.g., camera feed, child/handle status, handle feature controls, etc.) via the infotainment system (e.g., Apple CarPlay, or Android Auto). In some examples, the system can communicate directly via/with vehicles, such as via built-in vehicle cellular modem to communicate with 911, On-star, etc. In some examples the system associated with the car seat can assess whether it is in a vehicle by scanning Bluetooth devices associated with the vehicle, or dongle placed in vehicle (fixed to vehicle, or a portable device). Likewise, the various other systems can communicate with (and monitor) the car seat.

The monitoring system 100 can also aid with monitoring an impact status of the monitored environment. For example, a clip, a handle, or any other relevant part of a monitored environment, can include an accelerometer or other sensor to monitor motion to detect when a movement exceeding a predefined motion threshold occurs. This may be due to a car accident, for instance, or excessive force moving a car seat around (e.g., a seat is thrown into a cargo hold on an airplane). The system 100 can detect motion that exceeds the threshold and notify a user of the impact. The predefined motion threshold can be configured based on the environment. For instance, a certain amount of jarring/movement is expected for a car seat moving in a vehicle or a stroller that is in motion. However, an expected amount of movement for a crib is lower than that of a moving car seat so the predefined motion threshold may be set lower, depending on the item to monitor.

### Handle-Based Settings

Features can also be intelligently adjusted based on a handle position. FIG. 4 illustrates exemplary handle positions that are achieved by depression of handle releases 414. A lock indicator 412 is also provided to ensure the handle is in a locked position before relying on said position. Exemplary positions noted in FIG. 4 include a stand position 402, a travel position 404, a convenience position 406, a carry position 408, and a front position 410. The stand position 402, for instance, can trigger the system 100 to automatically deactivate as it is in an “unused” mode. The system 100 can be configured to measure fiducials, positioning, child placement, etc., from a plurality of handle positions. For instance, the system 100 can intelligently identify the handle is in a carry position 408 and utilize reference data (e.g., fiducial distance) to measure positioning. In contrast, if the system 100 determines that the handle is in the front position then a different set of reference data may be used to measure positioning. In aspects, any one of the illustrated handle positions can be associated with a set of reference data to accurately position the seat and child therein.

In examples, the handle position can be determined using one or more sensors. For instance, the sensor 108 can determine a position of the handle based on image data, motion data, position data, etc. In addition, one or more sensors can be associated with the handle release 414 and/or with a hub 416 used to rotatably support the handle relative to the carrier. In examples, handle position can be determined based on selective activation of switches or sensors (e.g., gray codes), tilt switches, and using the camera to check the position of (or lack of) fixed seat fiducials to calculate a position. In other aspects, handle position can be determined using an accelerometer to measure the angle of the handle.

The carry position 408 can trigger the system 100 to automatically initiate under lighting and/or forward lighting. When a user is carrying the seat, the system 100 automatically detects the handle position and can provide appropriate under lighting and forward lighting. Lights can be further activated/adjusted based on motion detection and brightness detection. For instance, an accelerometer of system 100 can detect that the handle is in the carry position 408 and detect the motions of walking to confirm this mode.

The travel position 404 can be used to place the seat forward facing in stroller applications. The system 100 can automatically enable front facing illumination lights and side safety lights for the forward facing functionality.

Front position 410 can be used for normal vehicle travel. Vehicle usage features can be enabled with this handle position including activating the camera, checking for a buckle status, opening the child monitoring application and streaming an image of the child, nightlights, entertainment lights, etc. This mode can also be used in the stroller when soothing functionality is desired and front lighting mode isn't needed.

### Installation

The monitoring system 100 can also provide instructions to users, via the child monitoring application 104, regarding the installation of the car seat 106. Alerts can also be provided to the user if installation is determined improper. The monitoring system 100 can be used in this manner by utilizing a camera accelerometer to measure angles relative to down (e.g., gravity). A user could confirm they are parked on flat ground or measure the vehicle's angle by placing a measuring device (e.g., their mobile phone) on the vehicle's floor. From this, the resulting angle of the car seat can be calculated. The monitoring system 100 can verify the seat is installed at an appropriate angle for the child's age, weight, and height.

The car seat 106 installation tightness can also be evaluated by the monitoring system 100. Using the same angle measurements described above, the camera accelerometer can instruct the user to forcefully push and pull on predetermined points of the car seat 106. Deflection of the seat from its original angle will be measured to be sure the car seat 106 is tight enough. If the deflection exceeds a predetermined deflection amount, a warning can be communicated to the user. In examples, push/pull points can be buttons, force sensors, strain gauges, etc. that accurately detect the amount of force applied to check expected displacement of the seat vs. force.

Having described embodiments of the present disclosure, an exemplary operating environment in which embodiments of the present disclosure may be implemented is described below in order to provide a general context for various aspects of the present disclosure. Referring to FIG. 6 in particular, an exemplary operating environment for implementing embodiments of the present disclosure is shown and designated generally as the computing device 600. The computing device 600 is one example of a suitable computing environment and is not intended to suggest any limitation as to the scope of use or functionality of the present disclosure. Neither should the computing device 600 be interpreted as having any dependency or requirement relating to any one or combination of components illustrated.

Aspects of the present disclosure may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. Aspects of the present disclosure may be practiced in a variety of system configurations, including hand-held devices, consumer electronics, general-purpose computers, more specialty computing devices, etc. Aspects of the present disclosure may also be practiced in distributed computing environments where tasks are performed by remote-processing devices that are linked through a communications network.

With reference to FIG. 6, the computing device 600 includes a bus 610 that directly or indirectly couples the following devices: a memory 612, one or more processor(s) 614, one or more presentation component(s) 616, input/output (I/O) port(s) 618, input/output components 620, an illustrative power supply 622, and radio(s) 624. The bus 610 represents what may be one or more busses (such as an address bus, a data bus, or a combination thereof). Although various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventor recognizes that such is the nature of the art and reiterates that the diagram of FIG. 6 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 6 and with reference to the term “computing device.”

The computing device 600 typically includes a variety of computer-readable media. The computer-readable media can be any available media that can be accessed by the computing device 600 and includes both volatile and nonvolatile media, and removable and non-removable media. By way of non-limiting example, the computer-readable media may comprise computer storage media and communication media. The computer storage media includes both volatile and nonvolatile, removable, and non-removable media implemented in any method or technology for storage of information, such as computer-readable instructions, data structures, program modules or other data. The computer storage media includes, but is not limited to, random-access memory (RAM), read-only memory (ROM), electronically erasable programmable read-only memory (EEPROM), flash memory or other memory technology, compact disc read-only memory (CD-ROM), digital versatile disks (DVDs) or other optical disk storage, magnetic cassettes, magnetic tape, magnetic disk storage or other magnetic storage devices, or any other medium which can be used to store the desired information and which can be accessed by the computing device 600. The computer storage media does not comprise signals per se. The communication media typically embodies computer-readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of non-limiting example, the communication media includes wired media, such as a wired network or direct-wired connection, and wireless media, such as acoustic, RF, infrared and other wireless media. Combinations of any of the above should also be included within the scope of computer-readable media.

The memory 612 includes computer-storage media in the form of volatile and/or nonvolatile memory. The memory 612 may be removable, non-removable, or a combination thereof. Exemplary hardware devices include solid-state memory, hard drives, optical-disc drives, etc. The computing device 600 includes one or more processor(s) 614 that read data from various entities such as the memory 612 or the I/O components 620. The presentation component(s) 616 present data indications to the user or other device. Exemplary presentation component(s) 616 include a display device, a speaker, a printing component, a vibrating component, etc.

The I/O port(s) 618 allow the computing device 600 to be logically coupled to other devices including the I/O components 620, some of which may be built in. Illustrative components include a microphone, a joystick, a game pad, a satellite dish, a scanner, a printer, a wireless device, etc. The I/O components 620 may provide a natural user interface (NUI) that processes air gestures, voice, or other physiological inputs generated by the user. In some instances, inputs may be transmitted to an appropriate network element for further processing. The NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be equipped with depth cameras, such as stereoscopic camera systems, infrared camera systems, RGB camera systems, touchscreen technology, and combinations of these, for gesture detection and recognition. Additionally, the computing device 600 may be equipped with accelerometers or gyroscopes that enable detection of motion. An output of the accelerometers or the gyroscopes may be provided to the display of the computing device 600 to render immersive augmented reality or virtual reality.

As can be understood, embodiments of the present disclosure provide for, among other things, monitoring an environment and adjusting one or more features of the environment based on monitored inputs. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that the present disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. Moreover, although the terms “step” and/or “block” may be used herein to connote different elements of methods employed, the terms should not be interpreted as implying any particular order among or between various steps disclosed herein unless and except when the order of individual steps is explicitly described. The examples herein are intended in all respects to be illustrative rather than restrictive. In this sense, alternative examples or implementations can become apparent to those of ordinary skill in the art to which the present subject matter pertains without departing from the scope hereof.

What is claimed is:

1. A child monitoring system comprising:
one or more processors to:
receive at least one input from one or more input devices of a car seat;
determine that a child is present in the car seat based on the at least one input; and
upon determining that the child is present in the car seat, activate one or more presence-based features including automatically communicating a notification to a computing device separate from the car seat.

2. The child monitoring system of claim 1, wherein the one or more input devices comprises a camera device.

3. The child monitoring system of claim 1, wherein the one or more input devices comprises a car seat buckle.

4. The child monitoring system of claim 1, wherein the one or more processors further verify that the child is present in the car seat.

5. The child monitoring system of claim 4, wherein a manual verification from a user is requested to verify that the child is present in the car seat.

6. The child monitoring system of claim 1, wherein the computing device separate from the car seat is a mobile device.

7. The child monitoring system of claim 1, wherein the one or more presence-based features comprises lighting.

8. The child monitoring system of claim 1, wherein the one or more presence-based features comprises sound.

9. The child monitoring system of claim 1, wherein the one or more processors further communicate an alert to the computing device when a change in presence is detected.

10. The child monitoring system of claim 9, wherein the alert is one or more of an audible alert and a visual alert.

11. A child monitoring system, comprising:
one or more input devices to identify a plurality of fiducial markers; and
one or more processors to:
determine, using the fiducial markers, one or more position values comprising a child head position, a buckle position, and a harness tightness; and
communicate an alert to a separate device indicating that an adjustment of at least one of the one or more position values is required.

12. The child monitoring system of claim 11, wherein the one or more processes are further configured to provide a graphic overlay to guide the adjustment of the at least one of the one or more position values.

13. The child monitoring system of claim 11, wherein the one or more input devices comprises a camera device.

14. The child monitoring system of claim 11, wherein the one or more input devices comprises a car seat buckle.

15. The child monitoring system of claim 11, wherein the alert is one or more of an audible alert and a visual alert.

16. A method, comprising:
identifying, via one or more sensors monitoring a handle position, a position of a handle of a car seat;
based on the one or more sensors identifying that the position of the handle of the car seat is in a first position, determining a presence of a child in the car seat; and
activating one or more features based on each of the presence of the child and the first position of the handle.

17. The method of claim 16, further comprising identifying that the handle has moved to a second position.

18. The method of claim 17, further comprising activating one or more second position features associated with the second position.

19. The method of claim 18, wherein the second position features include one or more of sound and lights.

20. The method of claim 17, further comprising deactivating one or more features based on the handle being in the second position.
